(19) United States
(12) Patent Application Publication
(10) Pub. No.: US 2011/0305224 A1
(43) Pub. Date: Dec. 15, 2011

(54) METHOD AND SYSTEM FOR ADAPTIVE DOWNLINK SIGNALING DETECTION USING DYNAMIC DOWNLINK SIGNALING POWER DISTRIBUTION PROFILES

(76) Inventor: Jamie Menjay Lin, San Marcos, CA (US)

(21) Appl. No.: 12/813,741

(22) Filed: Jun. 11, 2010

(51) Int. Cl. H04W 72/12

(52) U.S. Cl. 370/336

(57) ABSTRACT

A UE receives a downlink signaling signal in a current TTI over E-AGCH, E-RGCH or E-HICH. A downlink signaling power profile is established for the current TTI utilizing noise variance estimates and downlink signaling power estimates for the current TTI and prior TTIs. Commands such as UP or HOLD in the received downlink signaling signal are determined based on the established downlink signaling power profile. Candidate detection threshold values may be initially selected based on a current noise variance estimate. Distribution statistics, over the selected candidate detection threshold values, of the downlink signaling power estimates in the current TTI and the prior TTIs are determined for establishing the downlink signaling power profile. A detection threshold value is determined based on the current noise variance estimate and a metric derived from the established downlink signaling power profile to determine the commands for managing uplink data transmissions in subsequent TTIs.

### CROSS-REFERENCE TO RELATED APPLICATIONS/INCORPORATION BY REFERENCE

Not Applicable.

### FIELD OF THE INVENTION

Certain embodiments of the invention relate to communication systems. More specifically, certain embodiments of the invention relate to a method and system for adaptive downlink signaling detection using dynamic downlink signaling power distribution profiles.

### BACKGROUND OF THE INVENTION

The 3GPP represents a major advance in cellular technology. The 3GPP is designed to meet carrier needs for high-speed data and media transport as well as high-capacity voice support. It encompasses high-speed data, multimedia unicast and multimedia broadcast services. The 3GPP air interface standards aim to reduce delays, improve spectrum flexibility, and reduce cost for operators and end users. For example, the 3GPP physical layer (PHY) specifies a highly efficient means of conveying both data and control information between a base station (NodeB) and user equipment (UE).

3 G communication systems comprise a high speed downlink data service known as the High Speed Downlink Packet Access (HSDPA) service, and a high speed uplink data service known as High Speed Uplink Packet Access service (HSUPA). New physical channels are added for HSDPA and HSUPA in the 3GPP specifications to provide modified modulation formats and code rates in response to dynamic variations in the radio environment. For example, in HSUPA, Enhanced Dedicated Physical Data Channel (E-DPDCH) and Enhanced Dedicated Physical Control Channel (E-DPCCH) are added in the uplink, and Enhanced Hybrid Indicator Channel (E-HICH), Enhanced Absolute Grant Channel (E-AGCH) and Enhanced Relative Grant Channel (E-RGCH) are added in the downlink, respectively, to support efficient transfer of packet data traffic over an Enhanced Dedicated Channel (E-DCH). In the uplink, E-DPDCH carries user data to network. E-DPCCH may comprise the Layer 1 (physical layer) control information necessary for the base station to be able to demodulate and decode corresponding E-DPDCH. In the downlink, E-HICH is utilized to signal an acknowledge message (ACK/NACK) to specific UEs. E-AGCH may signal absolute values for a Serving Grant (SG). E-RGCH signals the incremental UP/DOWN/HOLD adjustments to the UE's SG.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for adaptive downlink signaling detection using dynamic downlink signaling power distribution profiles, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary communication system that is operable to adaptively detect downlink signaling using dynamic downlink signaling power distribution profiles, in accordance with an embodiment of the invention.

FIG. 2 is a block diagram illustrating exemplary user equipment that is operable to dynamically establish downlink signaling power distribution profiles for adaptive downlink signaling detection, in accordance with an embodiment of the invention.

FIG. 3 is a flow chart illustrating exemplary steps that may be performed by user equipment for adaptive downlink signaling detection using dynamic downlink signaling power distribution profiles, in accordance with an embodiment of the invention.

FIG. 4 is a block diagram illustrating exemplary steps that may be performed by a user equipment to dynamically establish downlink signaling power distribution profiles, in accordance with an embodiment of the invention.

FIG. 5 is a block diagram illustrating exemplary steps that may be performed by a user equipment to select an adaptive detection threshold value for downlink signaling detection, in accordance with an embodiment of the invention.

### DETAILED DESCRIPTION OF THE INVENTION

Certain embodiments of the invention may be found in a method and system for adaptive downlink signaling detection using dynamic downlink signaling power distribution profiles. In various embodiments of the invention, a UE may be operable to receive a downlink signaling signal over a downlink signaling channel such as E-AGCH, E-RGCH or E-HICH in a current TTI, for example. In response, the UE may establish a downlink signaling power profile for the current TTI utilizing noise variance estimates and downlink signaling power estimates calculated in the current TTI and one or more prior TTIs. One or more downlink signaling commands such as UP, DOWN, or HOLD that are carried in the received downlink signaling signal in the current TTI may be determined based on the established downlink signaling power profile for the current TTI. In this regard, the UE may initially select a set of candidate detection threshold values based on a noise variance estimate calculated in the current TTI. The downlink signaling power estimates calculated in the current TTI and the one or more prior TTI may be utilized to determine distribution statistics over the selected set of candidate detection threshold values. The determined distribution statistics may be utilized to establish the downlink signaling power profile for the current TTI. A metric may be derived or calculated from the established downlink signaling power profile for the current TTI. A detection threshold value utilized for the current TTI may be determined based on the noise variance estimate calculated in the current TTI and the calculated metric. The downlink signaling power that is calculated from the received downlink signaling signal in the current TTI may be compared with the determined detection threshold value. One or more downlink signaling commands such as UP, DOWN or HOLD may be determined based on the comparison. The UE may manage the uplink data transmission in one or more subsequent TTIs based on the determined one or more downlink signaling commands in the current TTI.

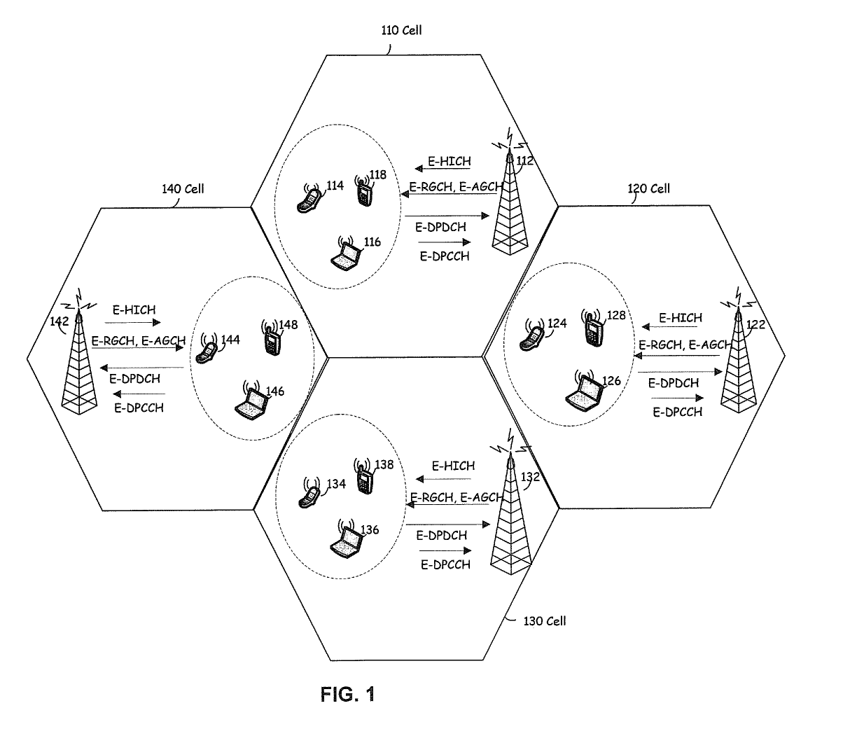

FIG. 1 is a diagram illustrating an exemplary communication system that is operable to adaptively detect downlink signaling using dynamic downlink signaling power distribution profiles, in accordance with an embodiment of the invention. Referring to FIG. 1, there is shown a communication system 100. The communication system 100 comprises cells 110-140. Each of the cells 110-140 comprises a base station and a plurality of user equipment (UEs), of which base stations 112-142 and UEs 114-118, 124-128, 134-138 and 144-148 are illustrated for the cells 110-140, respectively.

The cells 110-140 comprise geographical areas covered or served by the base stations 112, 122, 132 and 142, respectively. A cell such as the cell 110 may be identified by a unique cell identifier (Cell-ID). For each UE within the communication system 100, a cell may operate as an active cell, a candidate cell or a neighbor cell. With regard to a particular UE, an active cell is a cell that is currently connected to the particular UE. An active cell from which the particular UE receives grants for resource scheduling and/or other signaling is called a serving cell for the particular UE. A candidate cell is a cell that is not currently connected to the particular UE, but with associated pilot or reference signals strong enough to be added to an active cell list for the particular UE. A neighbor cell is a cell that is continuously measured by the particular UE and corresponding pilot or reference signals are not strong enough to be added to the active cell list for the particular UE. One or more neighbor cells may be associated with the particular UE.

A base station such as the base station 112 may comprise suitable logic, circuitry, interfaces and/or code that are operable to manage and schedule communication resources in an uplink direction and/or downlink direction within the cell 110. In HSUPA, the base station 112 may utilize a new transport channel named Enhanced Dedicated Channel (E-DCH) to improve the uplink data rates and reduce the delays in dedicated channels in the uplink. The E-DCH comprises five new physical channels known as Enhanced HARQ Acknowledgment Indicator Channel (E-HICH), Enhanced Dedicated Physical Data Channel (E-DPDCH), Enhanced Dedicated Physical Control Channel Control channel (E-DPCCH), Enhanced Relative Grant Channel (E-RGCH), and Enhanced Absolute Grant Channel (E-AGCH). The E-HICH may provide feedback information (ACK/NACK) on a Hybrid Automatic Repeat reQuest (HARQ) protocol. The E-DPDCH is a physical channel that is utilized for user data transmissions. The E-DPCCH that is associated with the E-DPDCH may provide information to the base station 112 on how to decode the E-DPDCH.

Since the E-DCH is a dedicated channel, multiple UEs may transmit at the same time, causing interference at the base station 112. In this regard, the base station 112 may be operable to utilize downlink scheduling channels E-RGCH and E-AGCH to manage or control how a UE such as the UE 114 may regulate its transmit power level and/or transmission time intervals. The base station 112 may issue scheduling grants once per transmission time interval (TTI) or at a slower rate to indicate to associated UEs such as the UE 114 the maximum amount of uplink resources the UE 114 may utilize. For example, upon receiving a scheduling request from the UE 114, the base station 112 may be operable to respond to the UE 114 with an access grant message over scheduling channels E-AGCH or E-RGCH if it allows the UE 114 to send uplink data. The access grant message may comprise a scheduling assignment (SA) that the UE 114 may utilize for data transmission on the E-DCH. The SA may comprise power grant, physical resource grant, UE ID and E-HICH Indicator (EI). The power grant may specify the power level allocated to the UE 114. On the one hand the E-RGCH may instruct the UE 114 either to increase or decrease the transmit power level on the E-DCH by one step, or to keep the current transmit power level. The relative grant value may be set to +1, 0, or −1 to indicate the logical values of Up, Hold, or Down, respectively.

On the other hand the E-AGCH may demand an absolute value for the transmit power level at which the UE 114 may be allowed to transmit on the E-DCH. The physical resource grant may be denoted by means of a code and a timeslot component, for example. The UE ID may be E-DCH Radio Network Temporary Identifier (E-RNTI) and may be utilized to identify which UE the access grant is given to. EI may indicate or inform the UE 114 of which E-HICH the base station 112 may be utilized to convey an acknowledgement message (ACK or NACK) to the UE 114. The E-HICH may provide a mapping from +1, −1 to the logical values of ACK or NACK, respectively. The base station 112 may receive data transmissions or retransmissions from the UE 114 subsequent to a successful downlink signaling detection on E-AGCH, E-RGCH, and/or E-HICH at the UE 114.

A UE such as the UE 114 may comprise suitable logic, circuitry, interfaces and/or code that are operable to receive and/or transmit radio frequency signals from and/or to the base station 112. For example, in HSUPA, in instances where new data occurs for transmission in the UE 114, the UE 114 may send a scheduling request to its serving base station such as, for example, the base station 112, for required resources. The UE 114 may be operable to monitor downlink signaling channels such as E-AGCH and/or E-RGCH for a SA from the base station 112. In this regard, the UE 114 may be operable to perform downlink signaling detection on E-AGCH, E-RGCH and/or E-HICH. The detected downlink signaling signals on E-AGCH, E-RGCH and/or E-HICH may be decoded in order to manage the transmission of the new data in the UE 114 to the base station 112.

In an exemplary embodiment of the invention, the UE 114 may be operable to establish and evaluate downlink signaling power distribution profiles in run-time. In this regard, the UE 114 may be operable to track or estimate noise variance and downlink signaling power once per TTI. A downlink signaling power distribution profile may be established or created in each TTI based on the noise variance estimates and the downlink signaling power estimates. A downlink signaling power distribution profile for a current TTI may be established utilizing noise variance estimates and downlink signaling power estimates calculated in the current TTI as well as in one or more prior TTIs. Specifically, a detection threshold array may be selected based on the current noise variance estimate. The selected detection threshold array may comprise a plurality of candidate detection threshold values. A number of downlink signaling power estimates, calculated in the current TTI and one or more prior TTIs, failing in various intervals of the candidate detection threshold values in the selected detection threshold array may be collected to establish a downlink signaling power distribution profile for the current TTI. In this regard, the established downlink signaling power distribution profile for the current TTI comprise distribution statistics of the calculated downlink signaling power estimates in the current TTI and one or more prior TTIs over the selected detection threshold array.

In an exemplary embodiment of the invention, a detection threshold value may be dynamically selected for downlink signaling detection performed in a specific TTI such as a current TTI. In this regard, a metric associated with the established downlink signaling power distribution profile for the current TTI may be calculated based on the collected distribution statistics of the calculated downlink signaling power estimates in the current TTI and one or more prior TTIs. A detection threshold value for the current TTI may be selected or determined based on the calculated metric and the current noise variance estimate.

In an exemplary embodiment of the invention, the UE 114 may be operable to adaptively detect commands carried over E-AGCH, E-RGCH and/or E-HICH per TTI. In this regard, specific commands such as, for example, UP (+1), DOWN (−1), HOLD (0), ACK (+1) or NACK(−1) carried over E-AGCH, E-RGCH or E-HICH may be determined by comparing, for example, the current downlink signaling power estimate with the detection threshold value that is dynamically selected for the current TTI.

Although an adaptive downlink signaling detection using downlink signaling power profiles in a HSUPA communication system is illustrated in FIG. 1, the invention needs not be so limited. Accordingly, adaptively detecting downlink signaling using downlink signaling power profiles may also be utilized in any other communication systems that embody downlink signaling schemes without departing from the spirit and scope of various embodiments of the invention.

In an exemplary operation, a UE such as the UE 114 may be operable to communicate radio frequency signals with the base station 112 via various communication technologies such as HSUPA. In instances where the UE 114 has a need to transmit data to the base station 112, the UE 114 may be operable to send a scheduling request to the base station 112 for getting resources. The base station 112 may be operable to respond the UE 114 through a grant message over E-AGCH or E-RGCH. The grant message may comprise a SA for the UE 114 to support data transmission on the E-DCH. The UE 114 may be operable to monitor and detect downlink signaling over E-AGCH and/or E-RGCH. In this regard, the UE 114 may be operable to track noise variance and downlink signaling power so as to establish a downlink signaling power distribution profile for each TTI. Distribution statistics of downlink signaling power estimates calculated in, for example, a current TTI and one or more prior TTIs, may be collected over various intervals of a plurality of candidate detection threshold values to establish a downlink signaling power distribution profile for the current TTI. A metric may be calculated based on the established downlink signaling power distribution profile for the current TTI. A detection threshold value used for the current TTI may be selected based on the calculated metric and the current noise variance estimate. Commands carried in the downlink signaling over E-AGCH and/or E-RGCH may be determined by comparing the current downlink signaling power estimate with the selected detection threshold value for the current TTI. The UE 114 may be operable to select an appropriate transport format based on the determined commands for the data transmission to the base station 112 in one or more subsequent TTIs. The base station 112 may attempt to decode data transmissions from the UE 114. The base station 112 may communicate an acknowledge message (ACK/NACK) over E-HICH to the UE 114. The acknowledge message may be detected by the UE 114 following a downlink signaling detection discussed for E-AGCH or E-RGCH above. In case of NACK received, the UE 114 may retransmit data to the base station 112.

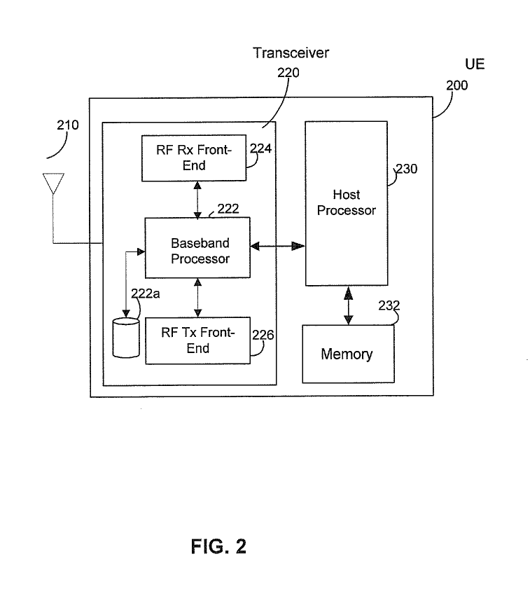

FIG. 2 is a block diagram illustrating exemplary user equipment that is operable to dynamically establish downlink signaling power distribution profiles for adaptive downlink signaling detection, in accordance with an embodiment of the invention. Referring to FIG. 2, there is shown user equipment (UE) 200 comprising an antenna 210, a transceiver 220, a host processor 230 and a memory 232. The transceiver 220 comprises a radio frequency (RF) receiver (Rx) front-end 224, a radio frequency (RF) transmitter (Tx) front-end 226 and a baseband processor 222. The baseband processor 222 may be communicatively coupled to a downlink signaling power profile database 222a.

The antenna 210 may comprise suitable logic, circuitry, interfaces and/or code that may be suitable for transmitting and/or receiving electromagnetic signals. Although a single antenna is illustrated, the invention is not so limited. In this regard, the transceiver 220 may be operable to utilize a common antenna for transmission and reception of radio frequency (RF) signals adhering to one or more wireless standards, may utilize different antennas for each supported wireless standard, and/or may utilize a plurality of antennas for each supported wireless standard. Various multi-antenna configurations may be utilized to take advantage of smart antenna technologies, diversity and/or beamforming, for example.

The transceiver 220 may comprise suitable logic, circuitry, interfaces and/or code that may be operable to transmit and/or receive RF signals adhering to one or more wireless standards such as the HSUPA standard.

The RF Rx front-end 224 may comprise suitable logic, circuitry, interfaces and/or code that may be operable to process RF signals received over, for example, HSUPA air interface, via the antenna 210. In this regard, the received RF signals may comprise downlink signaling transmissions over, for example, E-AGCH, E-RGCH or E-HICH. The RF Rx front-end 224 may be operable to convert the received RF signals to corresponding baseband signals. The resulting baseband signals may be communicated with the baseband processor 222 for further baseband processing such as downlink signaling detection on E-AGCH, E-RGCH and/or E-HICH.

The RF Tx front-end 226 may comprise suitable logic, circuitry, interfaces and/or code that may be operable to process RF signals for transmission. The RF Tx front-end 226 may be operable to receive baseband signals from the baseband processor 222 and convert the baseband signals to corresponding RF signals for transmission via the antenna 210.

The baseband processor 222 may comprise suitable logic, circuitry, interfaces and/or code that may be operable to manage and/or control operations of the RF Rx front-end 224 and the RF Tx front-end 226, respectively. The baseband processor 222 may be operable to communicate baseband signals with the transceiver 220. The baseband processor 222 may be operable to handle baseband signals to be transferred to the RF Tx front-end 226 for transmission and/or process baseband signals from the RF Rx front-end 224. In this regard, the received baseband signals may comprise downlink signaling signals received over E-AGCH, E-RGCH and/or E-HICH. The received downlink signaling signals may comprise commands such as UP (+1), DOWN (−1) and HOLD (0) carried on E-RGCH, and/or ACK (+1) or NACK(−1) carried on E-HICH to provide instructions to the UE 200 to adjust transmission power and/or manage data retransmission on the E-DCH.

In an exemplary embodiment of the invention, the baseband processor 222 may be operable to calculate or estimate noise variance and downlink signaling power in run-time once per TTI. Resulting noise variance estimates and downlink signaling power estimates may be stored in the downlink signaling power profile database 222a. The downlink signaling power profile database 222a may comprise suitable logic, circuitry, interfaces and/or code that may be operable to record and/or store cell measurements and downlink signaling power profiles when needed. The downlink signaling power profile database 222a may comprise RAM, ROM, low latency nonvolatile memory such as flash memory and/or other suitable electronic data storage. The downlink signaling power profile database 222a may be utilized to establish or generate downlink signaling power distribution profiles whenever needed. For example, in instances where a downlink signaling detection is performed in a current TTI, the baseband processor 222 may be operable to communicate with the downlink signaling power profile database 222a to acquire the stored noise variance estimates and downlink signaling power estimates in the current TTI and one or more prior TTIs to create a downlink signaling power profile for the current TTI. In an exemplary embodiment of the invention, the baseband processor 222 may be operable to select a detection threshold array according to the current noise variance estimate. The baseband processor 222 may be configured to collect a number of downlink signaling power estimates failing in various intervals in the selected detection threshold array for the current TTI and one or more prior TTIs to establish the downlink signaling power profile for the current TTI. The baseband processor 222 may be operable to dynamically select a detection threshold value based on the current noise variance estimate and a metric associated with the established downlink signaling power profile for the current TTI. The baseband processor 222 may detect commands carried over the downlink signaling channels such as E-AGCH, E-RGCH and/or E-HICH in the current TTI by comparing the current downlink signaling power estimate with the selected detection threshold value for the current TTI. According to the determined commands, the baseband processor 222 may be operable to manage data transmissions in one or more subsequent TTIs on the E-DCH to the base station 112 via the RF Tx Front-End 226.

The host processor 230 may comprise suitable logic, circuitry, interfaces and/or code that may be operable to manipulate and control operation of device components such as the transceiver 220. The host processor 230 may be operable to communicate data with the transceiver 220 to support applications such as, for example, audio streaming on the UE 200.

The memory 232 may comprise suitable logic, circuitry, and/or code that may enable storage of information such as executable instructions and data that may be utilized by the host processor 230 as well as the baseband processor 222. The executable instructions may comprise algorithms that may be applied to various baseband signal processes such as the detection of downlink signaling signals received over E-AGCH, E-RGCH or E-HICH. The memory 232 may comprise RAM, ROM, low latency nonvolatile memory such as flash memory and/or other suitable electronic data storage.

In an exemplary operation, the RF Rx front-end 224 may be operable to process RF signals received via the antenna 210 over the HSUPA air interface, for example. The received RF signals may comprise downlink signaling signals received over E-AGCH, E-RGCH or E-HICH. The baseband processor 222 may be operable to track or calculate noise variance and downlink signaling signal power in run-time once per TTI. The resulting noise variance estimates and downlink signaling power estimates may be stored in the downlink signaling power profile database 222a. In instances where the UE 200 needs to determine commands in the received downlink signaling signals in a current TTI, the stored noise variance estimates and downlink signaling power estimates in the current TTI and one or more prior TTIs may be utilized to create a downlink signaling power distribution profile for the current TTI. A detection threshold value for the current TTI may be selected based on the current variance estimate and a metric associated with the created downlink signaling power distribution profile for the current TTI. Downlink signaling commands such as UP (+1), DOWN (−1), HOLD (0), ACK (+1) or NACK (−1) carried over E-RGCH or E-HICH may be determined by comparing the current downlink signaling power estimate with the selected detection threshold value for the current TTIs. The baseband processor 222 may be operable to manage data transmissions in subsequent TTIs to the base station 112 via the RF Tx Front-End 226 based on the determined downlink signaling commands.

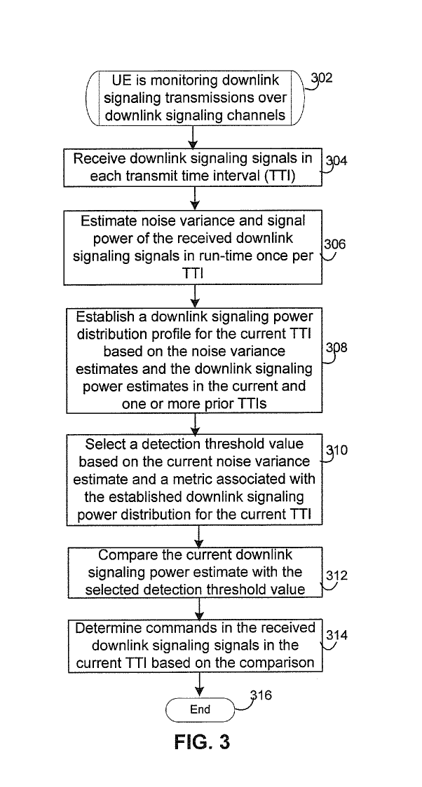

FIG. 3 is a flow chart illustrating exemplary steps that may be performed by user equipment for adaptive downlink signaling detection using dynamic downlink signaling power distribution profiles, in accordance with an embodiment of the invention. Referring to FIG. 3, the exemplary steps may start with step 302. In step 302, a UE such as the UE 114 in the cell 110 may be operable to monitor downlink signaling transmissions or signals over downlink signaling channels such as E-AGCH or E-RGCH. In step 304, the UE 114 may receive downlink signaling signals over E-AGCH, for example, in each TTI or at a lower rate. In step 306, the UE 114 may be operable to estimate or calculate noise variance and downlink signaling power for the received downlink signaling signals in run-time once per TTI. In step 308, the UE 114 may be operable to establish or create a downlink signaling power distribution profile for the current TTI utilizing the noise variance estimates and downlink signaling power estimates in the current and one or more prior TTIs. In step 310, a detection threshold value for the current TTI may be selected based on the current noise variance estimate and a metric associated with the established downlink signaling power distribution profile for the current TTI. In step 312, the UE 114 may be operable to compare the current downlink signaling power estimate with the selected detection threshold value. In step 314, the UE 114 may be operable to determine downlink signaling commands carried in the received downlink signaling signals in the current TTI based on the comparison. The exemplary steps may end in step 316.

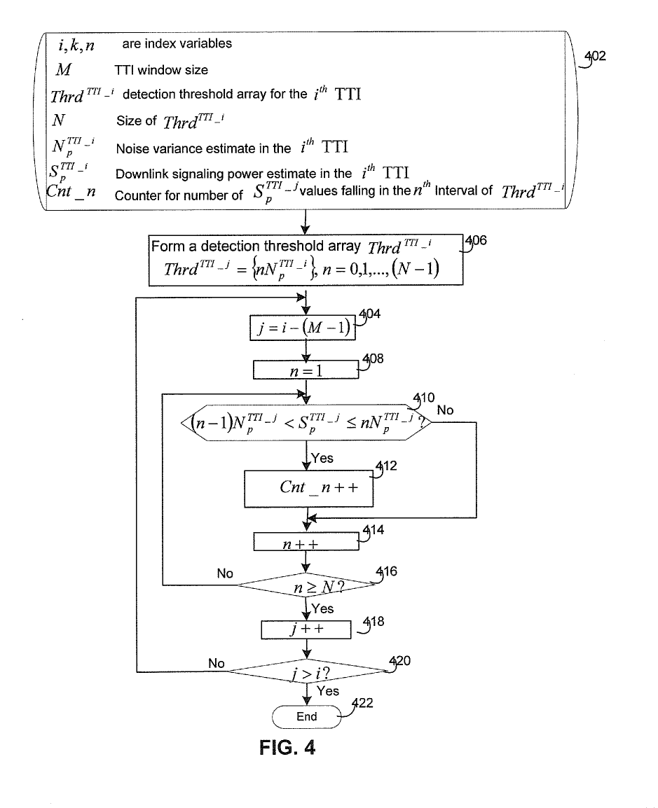

FIG. 4 is a block diagram illustrating exemplary steps that may be performed by a user equipment to dynamically establish downlink signaling power distribution profiles, in accordance with an embodiment of the invention. Referring to FIG. 4, the exemplary steps may start with step 402. In step 402, a UE such as the UE 114 in the cell 110 may need to create a downlink signaling power profile for the TTI. The parameters i,j,n are index variables. The parameter M indicates TTI window size, namely, the number of TTIs from which noise variance estimates and downlink signaling power estimates are utilized to establish the downlink signaling power profile for the i^{th} TTI. The detection threshold array Thrd^{TTI}^{_{—}}ⁱ is an array of size of N and comprises a set of pre-determined threshold values. The parameter Nₚ^{TTI}^{_{—}}ⁱ represents the noise variance estimate in the i^{th} TTI. The parameter Sₚ^{TTI}^{_{—}}ⁱ represents the downlink signaling power estimate in the i^{th} TTI. The parameter Cnt_n represents a counter for number of Sₚ^{TTI}^{_{—}}ⁱ values, within each of TTI in the TTI window, falling in the n^{th} interval of the Thrd^{TTI}^{_{—}}ⁱ. In step 404, the UE 114 may be operable to form the detection threshold array Thrd^{TTI}^{_{—}}ⁱ for the i^{th} TTI by Thrd^{TTI}^{_{—}}ⁱ={nNₚ^{TTI}^{_{—}}ⁱ }, n=0, 1, . . . , (N−1). In step 406, set j=i−(M−1) to start collecting Cnt_n in the j^{th} TTI. In step 408, set n=1 to start collecting Cnt_n in the n^{th} interval of the detection threshold array Thrd^{TTI}^{_{—}}ⁱ. In step 410, the UE 114 may be operable to check if the value of the Sₚ^{TTI}^{_{—}}ⁱ falls in the n^{th} interval of the detection threshold array Thrd^{TTI}^{_{—}}ⁱ, namely, (N−1)Nₚ^{TTI}^{_{—}}ⁱ<Sₚ^{TTI}^{_{—}}ⁱ≦nNₚ^{TTI}^{_{—}}ⁱ. In instances where the value of the Sₚ^{TTI}^{_{—}}ⁱ falls in the n^{th} interval of the detection threshold array Thrd TTI^{_{—}}ⁱ, then in step 412, the counter Cnt_n is increased by a step of 1. In step 414, the index n is increased by 1 for the next interval of the detection threshold array Thrd^{TTI}^{_{—}}ⁱ. In step 416, it may be determined if n≧N. In instances where n≧N, then in step 418, the index j is increased by 1 for the next TTI within the TTI window. In step 420, it may be determined whether j>i. In instances where j>i, then the downlink signaling power profile for the i^{th} TTI is established. The established downlink signaling power profile for the i^{th} TTI comprise information on number of downlink signaling power values, over the entire TTIs within the TTI window, falling in each of the detection threshold intervals. The exemplary steps may end in step 422.

In step 410, in instances where the value of the Sₚ^{TTI}^{_{—}}ⁱ does not fall in the n^{th} interval of the detection threshold array Thrd^{TTI}^{_{—}}ⁱ, then the exemplary steps may proceed to step 414. In step 416, in instances where n<N, then the exemplary steps return to step 410. In step 420, in instances where j≦i, then the exemplary steps return to step 406.

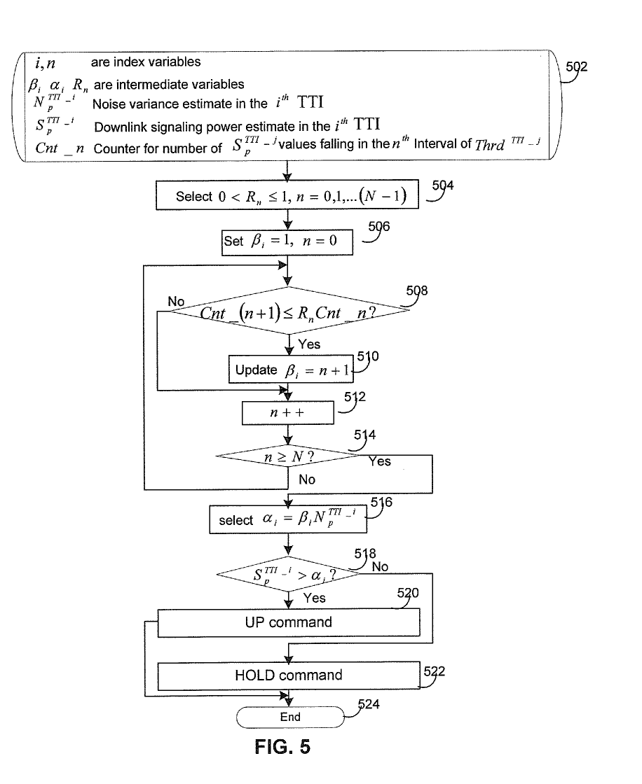

FIG. 5 is a block diagram illustrating exemplary steps that may be performed by a user equipment to select an adaptive detection threshold value for downlink signaling detection, in accordance with an embodiment of the invention. Referring to FIG. 5, the exemplary steps may start with step 502. In step 502, a UE such as the UE 114 in the cell 110 may have created a downlink signaling power profile for the i^{th} TTI. The parameters i,n are index variables. The parameter Nₚ^{TTI}^{_{—}}ⁱ represents the noise variance estimate in the i^{th} TTI. The parameter Sₚ^{TTI}^{_{—}}ⁱ represents the downlink signaling power estimate in the i^{th} TTI. The parameter Cnt_n represents a counter for number of Sₚ^{TTI}^{_{—}}ⁱ values, within each of TTI in the TTI window, falling in the n^{th} interval of the Thrd^{TTI}^{_{—}}ⁱ. The parameters βᵢ, αᵢ, and Rₙ are intermediate variables. In step 504, the UE 114 may select the parameters Rₙ such that 0<Rₙ≦1, n=0, 1 . . . (N−1). In step 506, set initial values β=1 and n=0. In step 508, it may be determined whether Cnt_ (n+1)≦RₙCnt_n. In instances where Cnt_ (n+1)≦RₙCnt_n, then in step 510, β, by βᵢ=n+1 is updated. In step 512, the index n is increased by 1. In step 514, it may be determined whether n≧N. In instances where N, then in step 516, a final detection threshold value is selected for the i^{th} TTI by αᵢ=βᵢNₚ^{TTI}^{_{—}}ⁱ. In step 528, it may be determined whether Sₚ^{TTI}^{_{—}}ⁱ>αᵢ. In instances where Sₚ^{TTI}^{_{—}}ⁱ>αᵢ, then in step 520, the command UP is received.

In step 508, in instances where Cnt_ (n+1)>RₙCnt_n, then the exemplary steps proceed in step 512. In step 514, in instances where, then the exemplary steps return to step 508. In step 528, in instances where Sₚ^{TTI}^{_{—}}ⁱ≦αᵢ, then in step 522, the command HOLD is received. The exemplary steps may end in step 524.

In various exemplary aspects of the method and system for adaptive downlink signaling detection using dynamic downlink signaling power distribution profiles, as described with respect to FIG. 1-FIG. 5, a UE such as the UE 114 may be operable to receive a downlink signaling signal over a downlink signaling channel such as E-AGCH, E-RGCH or E-HICH in a current TTI, for example. In response to the received downlink signaling signal, the UE 114 may be operable to establish a downlink signaling power profile for the current TTI utilizing noise variance estimates and downlink signaling power estimates calculated in the current TTI and one or more prior TTIs. One or more downlink signaling commands such as UP, DOWN, or HOLD that are carried in the received downlink signaling signal in the current TTI may be determined based on the established downlink signaling power profile for the current TTI. In this regard, the UE 114 may initially select a set of candidate detection threshold values based on a noise variance estimate calculated in the current TTI. The downlink signaling power estimates calculated in the current TTI and the one or more prior TTI may be utilized to determine distribution statistics over the selected set of candidate detection threshold values. The determined distribution statistics may be utilized to establish the downlink signaling power profile for the current TTI. A metric may be derived or calculated from the established downlink signaling power profile for the current TTI. A detection threshold value for the current TTI may be determined based on the noise variance estimate calculated in the current TTI and the calculated metric. The downlink signaling power that is calculated from the received downlink signaling signal in the current TTI may be compared with the determined detection threshold value. One or more downlink signaling commands such as UP or HOLD may be determined based on the comparison. The UE 114 may be operable to manage the uplink data transmission in one or more subsequent TTIs based on the determined one or more downlink signaling commands in the current TTI.

The grant message may comprise a SA for the UE 114 to support data transmission on the E-DCH. The UE 114 may be operable to monitor and detect downlink signaling over E-AGCH and/or E-RGCH. In this regard, the UE 114 may be operable to track noise variance and downlink signaling power so as to establish a downlink signaling power distribution profile for each TTI.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for adaptive downlink signaling detection using dynamic downlink signaling power distribution profiles.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a user equipment:
receiving a downlink signaling signal over a downlink signaling channel in a current Time Transmission Interval (TTI);
establishing, in response to said received downlink signaling signal, a downlink signaling power profile for said current TTI utilizing noise variance estimates and downlink signaling power estimates for said current TTI and one or more prior TTIs; and
determining one or more commands carried in said received downlink signaling signal based on said established downlink signaling power profile for said current TTI.

2. The method according to claim 1, wherein said downlink signaling channel is Enhanced Absolute Grant Channel (E-AGCH), Enhanced Relative Grant Channel (E-RGCH) or Enhanced HARQ Acknowledgment Indicator Channel (E-HICH).

3. The method according to claim 1, comprising selecting a set of candidate threshold values based on a noise variance estimate calculated in said current TTI.

4. The method according to claim 3, comprising determining distribution statistics of said downlink signaling power estimates calculated in said current TTI and said one or more prior TTIs over said selected set of candidate detection threshold values.

5. The method according to claim 4, comprising establishing said downlink signaling power profile for said current TTI based on said determined distribution statistics.

6. The method according to claim 5, comprising calculating a metric from said established downlink signaling power profile for said current TTI.

7. The method according to claim 6, comprising determining a detection threshold value for said current TTI based on said calculated metric and said noise variance estimate calculated in said current TTI.

8. The method according to claim 7, comprising comparing a downlink signaling power that is calculated from said received downlink signaling signal in said current TTI with said determined detection threshold value.

9. The method according to claim 8, comprising determining one or more commands carried in said received downlink signaling signal in said TTI based on said comparison.

10. The method according to claim 9, comprising managing uplink data transmissions in one or more subsequent TTIs based on said determined one or more commands in said current TTI.

11. A system for communication, the system comprising:
one or more processors and/or circuits for use in a user equipment, said one or more processors and/or circuits being operable to:
receive a downlink signaling signal over a downlink signaling channel in a current Time Transmission Interval (TTI);
establish, in response to said received downlink signaling signal, a downlink signaling power profile for said current TTI utilizing noise variance estimates and downlink signaling power estimates for said current TTI and one or more prior TTIs; and
determine one or more commands carried in said received downlink signaling signal based on said established downlink signaling power profile for said current TTI.

12. The system according to claim 11, wherein said downlink signaling channel is Enhanced Absolute Grant Channel (E-AGCH), Enhanced Relative Grant Channel (E-RGCH) or Enhanced HARQ Acknowledgment Indicator Channel (E-HICH).

13. The system according to claim 11, wherein said one or more processors and/or circuits being operable to select a set of candidate threshold values based on a noise variance estimate calculated in said current TTI.

14. The system according to claim 13, wherein said one or more processors and/or circuits being operable to determine distribution statistics of said downlink signaling power estimates calculated in said current TTI and said one or more prior TTIs over said selected set of candidate detection threshold values.

15. The system according to claim 14, wherein said one or more processors and/or circuits being operable to establish said downlink signaling power profile for said current TTI based on said determined distribution statistics.

16. The system according to claim 15, wherein said one or more processors and/or circuits being operable to calculate a metric from said established downlink signaling power profile for said current TTI.

17. The system according to claim 16, wherein said one or more processors and/or circuits being operable to determine a detection threshold value for said current TTI based on said calculated metric and said noise variance estimate calculated in said current TTI.

18. The system according to claim 17, wherein said one or more processors and/or circuits being operable to compare a downlink signaling power that is calculated from said received downlink signaling signal in said current TTI with said determined detection threshold value.

19. The system according to claim 18, wherein said one or more processors and/or circuits being operable to determine one or more commands carried in said received downlink signaling signal in said TTI based on said comparison.

20. The system according to claim 19, wherein said one or more processors and/or circuits being operable to manage uplink data transmissions in one or more subsequent TTIs based on said determined one or more commands in said current TTI.
